(19) United States
(12) Patent Application Publication
(10) Pub. No.: US 2014/0226133 A1
(43) Pub. Date: Aug. 14, 2014

(54) MULTIPROJECTION SYSTEM

(71) Applicant: So Nishimura, Tokyo (JP)

(72) Inventor: So Nishimura, Tokyo (JP)

(73) Assignee: NEC CORPORATION, Tokyo (JP)

(21) Appl. No.: 14/347,226

(22) PCT Filed: Aug. 1, 2012
(86) PCT No.: PCT/JP2012/069585

§ 371 Date: Mar. 25, 2014

(30) Foreign Application Priority Data
Sep. 27, 2011 (JP) 2011-211283

(51) Int. Cl. G03B 21/62; G03B 21/14

(52) U.S. Cl. CPC G03B 21/62; G03B 21/14
USPC 353/30

(57) ABSTRACT

Provided is a multiprojection system capable of preventing degradation in the quality of a displayed image to be while allowing detection of light that an adjacent projector projects to form an image. A plurality of projector units (1) each projects a formed image in such a way that the plurality of formed images are joined with each other to form a single displayed image. The plurality of formed images are projected on screen (10). A light transmitting, low refractivity layer (33) is provided at at least a part of a boundary line between the formed images on screen (10) and along the boundary line. A pair of light transmitting members (31 and 32) have a refractive index higher than the refractive index of low refractivity layer (33) and is provided so that the pair of light transmitting members (31 and 32) sandwich low refractivity layer (33).

### TECHNICAL FIELD

The present invention relates to a multiprojection display that includes a plurality of projector units each projecting a light beam on a screen to form an image, joins the images formed by the projector units with each other, and displays the single joined image.

### BACKGROUND ART

There is a known multiprojection system in which a plurality of rear-projection projector units each project light on a screen through the rear surface thereof to form an image on the screen and display the images formed by the projector units in the form of an array as a single displayed image.

In the multiprojection system described above, which usually uses a large screen that allows a large image to be displayed, a screen support member that supports the screen is attached to the rear surface of the screen so that the screen does not sag. The screen support member is, in some cases, made of a light transmitting material that transmits light to prevent a shadow of the screen support member from being visible to a viewer and is disposed along the boundaries between the images formed by the projector units (see Patent Literature 1).

Further, in the multiprojection system, because light sources of the projector units differ in luminance from each other due to manufacturing tolerances and becouse light output performance of each of the light sources changes over time, the images formed by the projector units differ in brightness from each other in some cases.

Human visual characteristics tend to cause a person to readily recognize a difference in brightness between areas close to each other. As a result, when the images formed by the projector units differ in brightness from each other, the difference in brightness between formed images adjacent to each other and the boundary between the formed images adjacent to each other tend to be readily recognized.

To address the problem, it is desirable in a multiprojection system that each of the projector units uses an optical sensor to detect part of the light that an adjacent projector unit projects to form an image and adjust the brightness of an image formed by the projector unit itself based on the detection result. The optical sensor is desirably disposed on the rear side of the screen because the optical sensor is likely to obstruct the view of the viewer when disposed on the front side of the screen.

Further, a projector unit used in a multiprojection system is configured, for example, to project light onto a screen that produces diffused light, such as fluorescence, and form an image based on the diffused light produced by the screen.

### CITATION LIST

### Patent Literature

Patent Literature 1: JP2006-145797A

### SUMMARY OF INVENTION

### Technical Problem

When a projector unit that forms an image with diffused light formed by a light beam as described above is used as each of the projector units in a multiprojection system, light that has not produced diffused light at the screen but has been simply reflected off the screen forms stray light, which is incident on areas where other projector units project light or incident on the optical sensors of other projector units, resulting in degradation in quality of a displayed image in some cases.

To block stray light, it is conceivable to form the screen support member by using a light blocking material that blocks light. In this case, however, light that an adjacent projector projects to form an image is also blocked, which means that the optical sensor cannot detect light that the adjacent projector unit projects to form an image and hence makes it difficult to adjust the brightness of an image formed by the projector unit itself.

An object of the present invention is to provide a multiprojection system capable of preventing degradation in quality of a displayed image while being capable of detecting light that an adjacent projector unit projects to form an image.

### Solution to Problem

A multiprojection system according to the present invention includes a plurality of projector units each projecting a formed image in such a way that the plurality of formed images are joined with each other to form a single displayed image, a screen on which the plurality of formed images are projected, a light transmitting, low refractivity area provided at at least a part of a boundary line between the formed images on the screen and along the boundary line, and a pair of light transmitting members having a refractive index higher than the refractive index of the low refractivity area and provided such that the pair of light transmitting members sandwich the low refractivity area.

### Advantageous Effect of Invention

The present invention allows degradation in the quality of a displayed image to be prevented while allowing detection of light that an adjacent projector projects to form an image.

### BRIEF DESCRIPTION OF DRAWINGS

FIG. 1 shows an example of a multiprojection system according to an exemplary embodiment.

FIG. 2 shows an example of the rear surface of a screen.

FIG. 3 shows an example of the functional configuration of a projector unit.

FIG. 4 is diagram describing the configuration of screen supports in more detail.

FIG. 5 is diagram describing operation of the multiprojection system.

FIG. 6 is diagram describing where an optical sensor is disposed.

FIG. 7 is diagram describing an example of the shape of a light transmitting member.

FIG. 8 shows other examples of the shape of the light transmitting member.

FIG. 9 shows other examples of the shape of the light transmitting member.

FIG. 10 shows another example of the rear surface of the screen.

### DESCRIPTION OF EMBODIMENT

An exemplary embodiment will be described below with reference to the drawings. In the following description, components having the same function have the same reference character, and no redundant description thereof will be made in some cases.

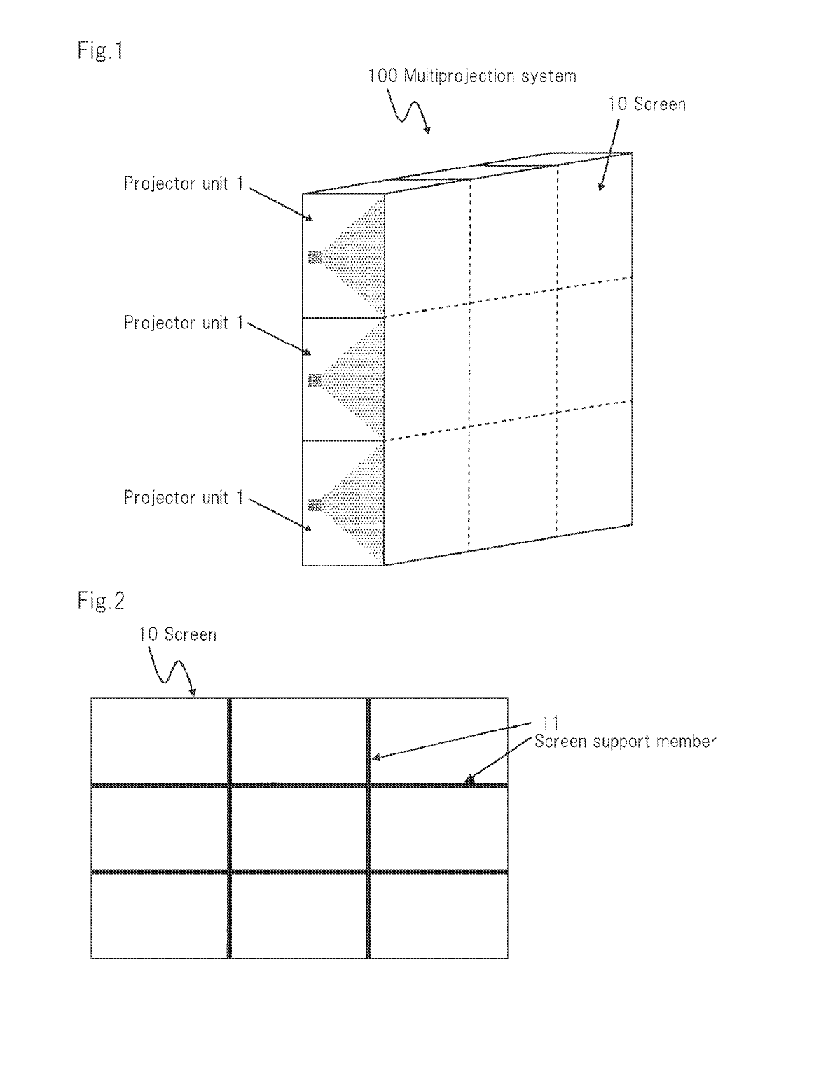

FIG. 1 shows an example of a multiprojection system according to an exemplary embodiment. In FIG. 1, multiprojection system 100 includes a plurality of projector units 1 and screen 10.

Each of projector units 1 is a rear-projection projector that projects laser light in the form of a laser beam onto screen 10 through the rear surface thereof to form an image on screen 10. The rear surface of screen 10 means the surface facing away from the front surface, which is the surface facing a viewer that is visually recognized by the viewer.

Further, projector units 1 are so disposed that the images formed by projector units 1 are displayed in the form of an array and the formed images are joined with each other to be displayed as a single displayed image. In the example shown in FIG. 1, projector units 1 are arranged in three rows and three columns, but the number and the arrangement of projector units 1 are not limited to those in the example and can be changed as appropriate.

FIG. 2 shows an example of the rear surface of screen 10. Screen support members 11, which support screen 10, are disposed on the rear surface of screen 10 along predetermined directions on the rear surface. More specifically, the predetermined directions are directions along the boundaries between the images formed by projector units 1, and screen supports 11 are made of a light transmitting material that transmits light and that are disposed along the boundaries between the formed images. Screen 10 and screen supports 11 are collectively referred to as a screen unit in some cases.

Further, screen 10 produces diffused light from light incident thereon, and each of projector units 1 projects laser light onto screen 10, which produces diffused light, and uses the diffused light to form an image.

Screen 10 described above may, for example, be a fluorescent screen. A fluorescent screen is formed by arranging a red fluorophore area containing a fluorophore that emits red fluorescence, a green fluorophore area containing a fluorophore that emits green fluorescence, and a blue fluorophore area containing a fluorophore that emits blue fluorescence periodically in a predetermined order. Another fluorescent screen may be so formed that a light blocking area that absorbs or reflects light and hence does not allow the light to exit forward through screen 10 is present in the form of stripes or a matrix between the color fluorophore areas. The fluorescence emitted from each of the color fluorophores is diffused light.

Screen 10 may instead be a screen other than the fluorescent screen described above. For example, part or the entire of the fluorophore areas of screen 10 may be replaced with diffusing areas that diffuse laser light.

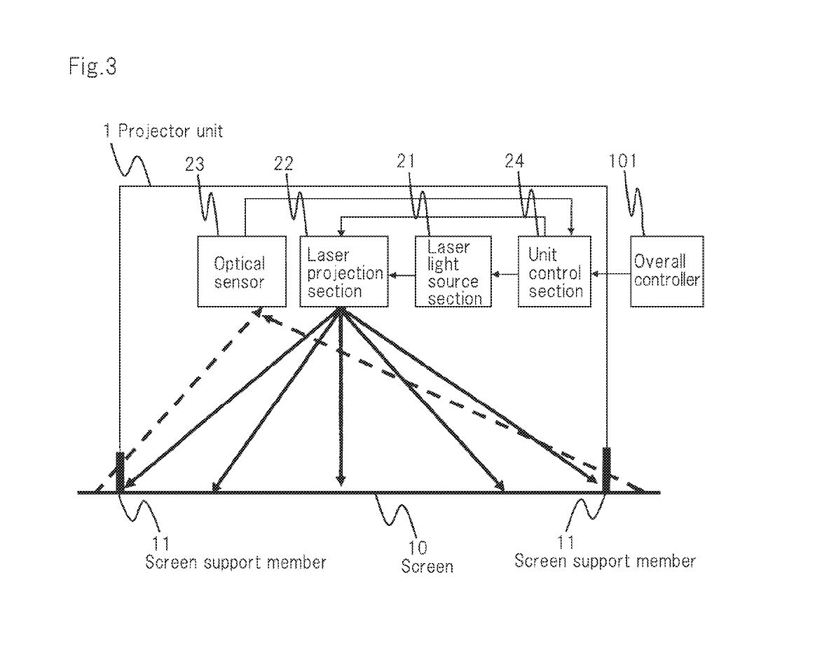

FIG. 3 shows the functional configuration of each of projector units 1. In FIG. 3, projector unit 1 includes laser light source section 21, laser projection section 22, optical sensor 23, and unit control section 24.

Laser light source section 21 is a light source that emits laser light and that is formed, for example, of an LD (Laser Diode). Laser projection section 22 projects the laser light emitted from laser light source section 21 through the rear surface of screen 10 to form an image on screen 10 based on diffused light produced by screen 10.

More specifically, laser projection section 22 two-dimensionally scans screen 10 with the laser light from laser light source section 21 by deflecting and outputting the laser light in two-dimensional directions. Further, unit control section 24 controls laser light source section 21 to modulate the laser light in synchronization with the two-dimensional scan performed by laser projection section 22. An image is thus formed on screen 10.

Optical sensor 23 is disposed on the rear side of screen 10. Optical sensor 23 is formed of a CCD image sensor, a CMOS image sensor, or any other imaging device or a PD (photodiode) including an APD (avalanche photodiode) or any other light detection device, detects the luminance of part of the light that projector unit 1 adjacent to projector unit 1 itself or simply called an adjacent unit projects to form an image, and outputs a detection signal representing the luminance.

Part of the laser light incident on screen 10 produces diffused light, whereas the remainder produces no diffused light but is simply reflected off screen 10. Part of the diffused light exits through the front surface of screen 10, whereas the remainder exits through the rear surface of scree 10. The part of the light that forms an image to be detected with optical sensor 23 is the diffused light that exits through the rear surface of screen 10. Further, optical sensor 23 detects the luminance of a specific pixel in a formed image on a color basis, that is, luminance for red, green, and blue. The specific pixel may be formed of a plurality of pixels.

Unit control section 24 is a control section that controls projector unit 1. Unit control section 24 receives a video signal and control information from overall controller 101, which controls entire multiprojection system 100, and receives the detection signal from optical sensor 23. The control information is, for example, used to set a variety of modes in projector unit 1 itself. Overall controller 101 and projector units 1 are collectively referred to as a projection apparatus in some cases.

Unit control section 24 drives laser light source section 21 and laser projection section 22 based on the video signal, the control signal, and the detection signal to form an image on screen 10.

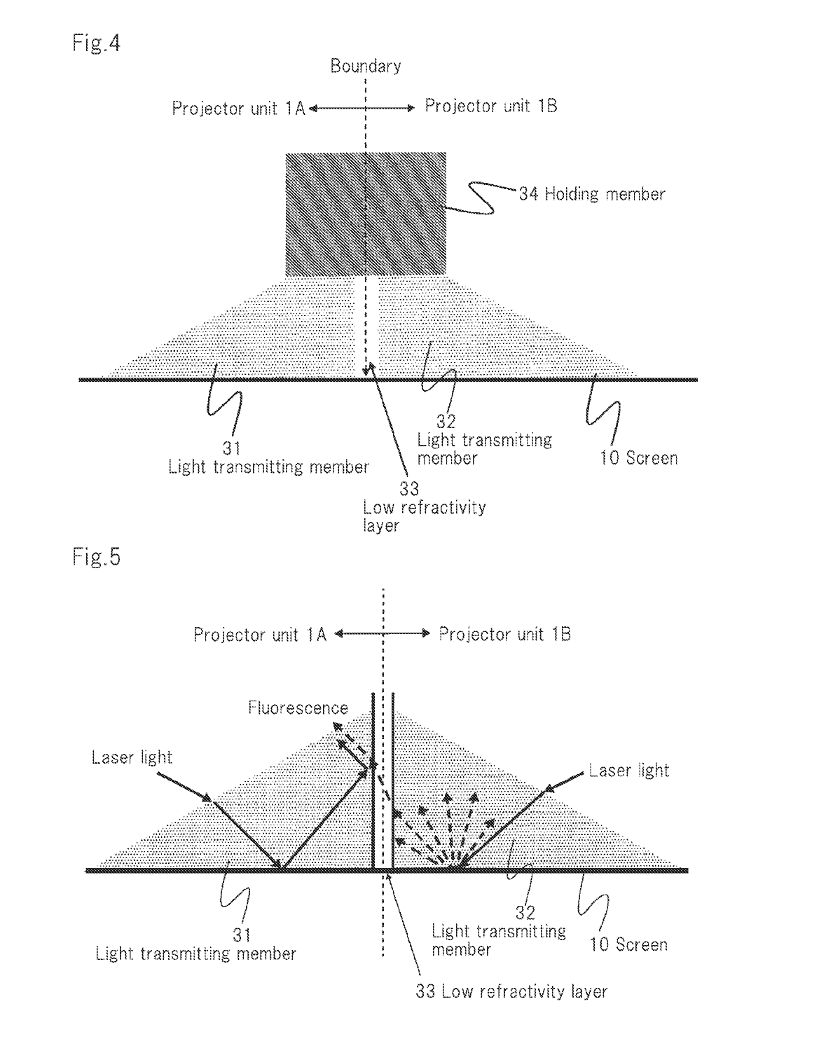

FIG. 4 is a diagram describing the configuration of each of screen supports 11 in more detail. FIG. 4 shows a transverse cross-sectional view of screen support 11 disposed along the boundary between projector units 1A and 1B, which are projector units 1 adjacent to each other in the transverse direction.

Screen support 11 includes a pair of light transmitting members 31 and 32, low refractivity layer 33, which is sandwiched between light transmitting members 31 and 32, and holding member 34, which holds both light transmitting members 31 and 32, as shown in FIG. 4.

Light transmitting members 31 and 32 are made of a light transmitting material that transmits light. Further, light transmitting members 31 and 32 are disposed on opposite sides of the boundary line between images formed by projector units 1A and 1B and along the boundary line. In FIG. 4, light transmitting member 31 is disposed on the side where projector unit 1A is present, and light transmitting member 32 is disposed on the side where projector unit 1B is present. The light transmitting material may, for example, be glass or a transparent resin.

Low refractivity layer 33 is an example of a low refractivity area. Low refractivity layer 33 is disposed along the boundary line between the images formed by projector units 1A and 1B and is made of a light transmitting material having a refractive index lower than the refractive index of light transmitting members 31 and 32. In the exemplary embodiment, a gap is provided between light transmitting members 31 and 32 and forms low refractivity layer 33. That is, low refractivity layer 33 is an air layer.

Low refractivity layer 33 may instead be formed by injecting a light transmitting material between light transmitting members 31 and 32 after projector units 1A and 1B are connected to each other and then by hardening the light transmitting material. Low refractivity layer 33 may instead still be formed as follows: After projector units 1A and 1B are connected to each other, a low refractivity material in a solid state may be placed as low refractivity layer 33 on screen 10; and light transmitting members 31 and 32 are further placed on screen 10 so that light transmitting members 31 and 32 sandwich low refractivity layer 33. Low refractivity layer 33 is desirably disposed on the light blocking area of screen 10.

Part of the laser light outputted from laser projection section 22 is reflected off screen 10 and incident on low refractivity layer 33, and setting the height of light transmitting members 31 and 32 to be equal to the height of low refractivity layer 33 allows the reflected laser light to be incident on low refractivity layer 33 via light transmitting member 31 or 32. Low refractivity layer 33 is further so formed that the laser light incident on low refractivity layer 33 via light transmitting member 31 or 32 is totally reflected off low refractivity layer 33.

Holding member 34 may be made of a light transmitting material but is desirably formed of a light blocking member that blocks light.

FIG. 5 is diagram describing operation of multiprojection system 100. In FIG. 5, a solid line with an arrow represents the laser light, and each dotted line with an arrow represents the diffused light.

For example, laser projection section 22A of each of projector units 1 scans a projection area on screen 10 where the same projector unit 1 projects light from the left end to the right end with the laser light, and when the laser light reaches the right end, the scanning resumes in such a way that the laser light travels back toward the left end. Laser projection section 22A then performs the scanning in such a way that the laser light travels back from the left end toward the right end again. The scanning described above is performed continuously from the upper side toward the lower side of the projection area.

During the scanning described above, for example, when the laser light from projector unit 1A is incident on light transmitting member 31, the laser light is refracted when incident on light transmitting member 31, and the refracted light passes through light transmitting member 31 and impinges on screen 10. In this process, when the position of the laser light projected on screen 10 falls within a fluorescent area, part of the laser light incident on screen 10 causes the fluorophores in screen 10 to produce diffused light, whereas the remainder is reflected off screen 10.

The laser light reflected off screen 10 is incident on low refractivity layer 33. The laser light incident on low refractivity layer 33 is totally reflected off the boundary between light transmitting member 31 and low refractivity layer 33 and exits toward projector unit 1A.

On the other hand, part of the diffused light exits through the front surface of screen 10, whereas the remainder exits through the rear surface of screen 10. Since the diffused light travels in a variety of directions, part of the diffused light that exits through the rear surface of screen 10 is incident on low refractivity layer 33. Part of the diffused light incident on low refractivity layer 33 is then totally reflected off low refractivity layer 33, whereas the remainder does not satisfy the total reflection condition and hence enters in low refractivity layer 33, is refracted and passes through low refractivity layer 33 and light transmitting member 32, and exits toward projector unit 1B.

Since projector unit 1B also operates in the same manner described above, part of the diffused light produced by projector unit 1B is incident on projector unit 1A. Optical sensor 23 in projector unit 1A detects the luminance of the diffused light incident on projector unit 1A.

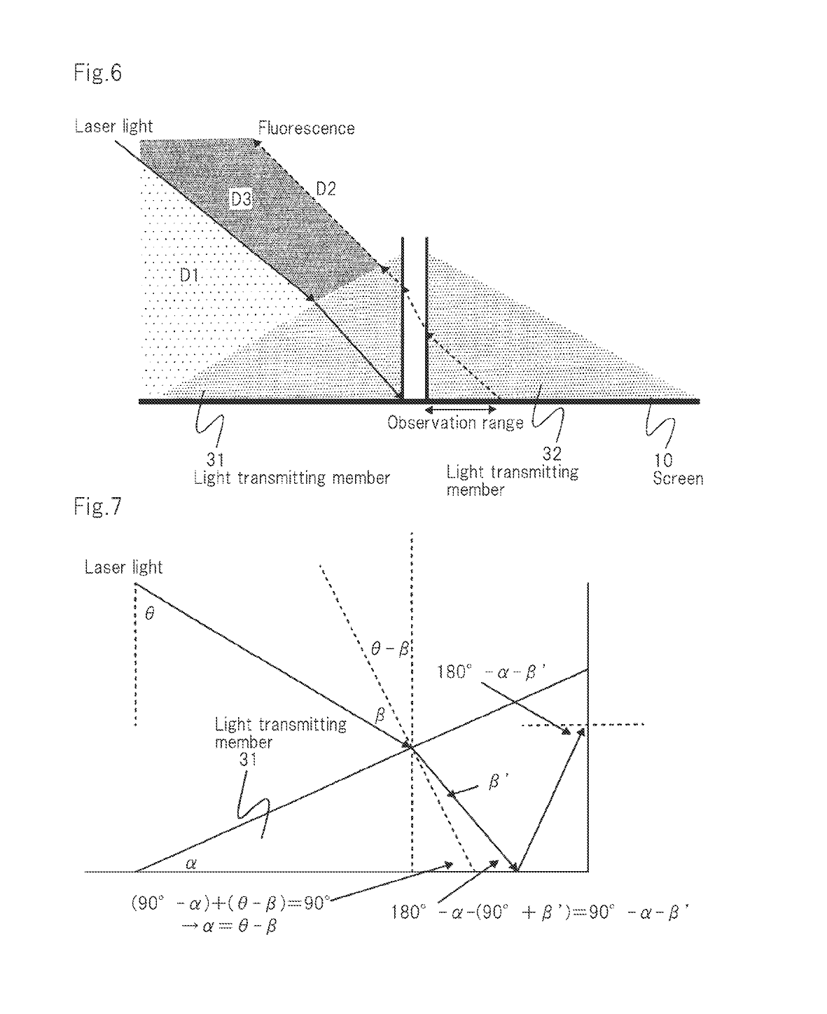

FIG. 6 is diagram describing where optical sensor 23 is disposed. It is assumed that the laser light scanning is performed until the laser light reaches the boundary between light transmitting member 31 and low refractivity layer 33. It is further assumed that the specific pixel whose the luminance is detected with optical sensor 23 is a pixel located within a predetermined observation range from the boundary between light transmitting member 32 and low refractivity layer 33.

It is undesirable to dispose optical sensor 23 in area D1 where the laser light outputted from laser projection section 22 passes through and directly impinges on screen 10. It is further undesirable to dispose optical sensor 23 in area D2 where the diffused light produced in a pixel located within the observation range of the adjacent unit is totally reflected off low refractivity layer 33 and hence is not incident on the module. Optical sensor 23 is therefore desirably disposed in an area through which the light produced in a pixel located within the observation range of the adjacent unit passes but which does not include area D1, that is, anywhere in area D3 sandwiched between area D1 and area D2.

The shape of light transmitting member 31 will next be described in more detail.

FIG. 7 is diagram describing an example of the shape of light transmitting member 31. Light transmitting member 31 is shaped to have an upward inclination with respect to the direction perpendicular to a boundary line between images formed by projector units 1, as shown in FIG. 7. α is the inclination angle, and θ is the scan angle in the scanning operation performed by laser projection section 22 in the direction perpendicular to the boundary line along which light transmitting member 31 is disposed. The two angles satisfy the following expression: the scan angle θ>the inclination angle α≧0. Further, n1 is the refractive index of a medium through which the laser light travels before it is incident on the light transmitting member; n2 is the refractive index of light transmitting member 31; and n3 is the refractive index of low refractivity layer 33.

In the example shown in FIG. 7, the angle of incidence β at which the laser light is incident on light transmitting member 31 is expressed by β=θ−α. Further, the angle of refraction β′ at which the laser light is refracted when it is incident on light transmitting member 31 is expressed based on Snell's law as follows:

n₁ sin β=n₂ sin β′ [Formula 1]

Further, the total reflection condition under which the laser light is totally reflected off low refractivity layer 33 is expressed by using the angles α and β′ as follows:

$$\frac{{n}_{2}}{{n}_{3}} sin ( \frac{π}{2} - α - {β}^{′} ) \geq 1 \qquad [ Formula 2 ]$$

The total reflection condition can be rewritten by using Expression 1 and the relationship of β=θ−α to a relationship between α and θ as follows:

$$\frac{{n}_{2}}{{n}_{3}} cos ( α + {β}^{′} ) \geq 1 \\ 0 \leq α + {β}^{′} \leq {cos}^{- 1} ( \frac{{n}_{3}}{{n}_{2}} ) \\ 0 \leq α + {sin}^{- 1} ( \frac{{n}_{1}}{{n}_{2}} sin β ) \leq {cos}^{- 1} ( \frac{{n}_{3}}{{n}_{2}} ) \\ 0 \leq α + {sin}^{- 1} ( \frac{{n}_{1}}{{n}_{2}} sin ( θ - α ) ) \leq {cos}^{- 1} ( \frac{{n}_{3}}{{n}_{2}} ) \qquad [ Formula 3 ]$$

Light transmitting member 31 may therefore be so shaped that the total reflection condition indicated by Formula 3 is satisfied.

The shape of light transmitting member 31 shown in FIG. 7 is presented only by way of example, and any shape that allows the laser light to be totally reflected off the boundary between light transmitting member 31 and low refractivity layer 33 can be used.

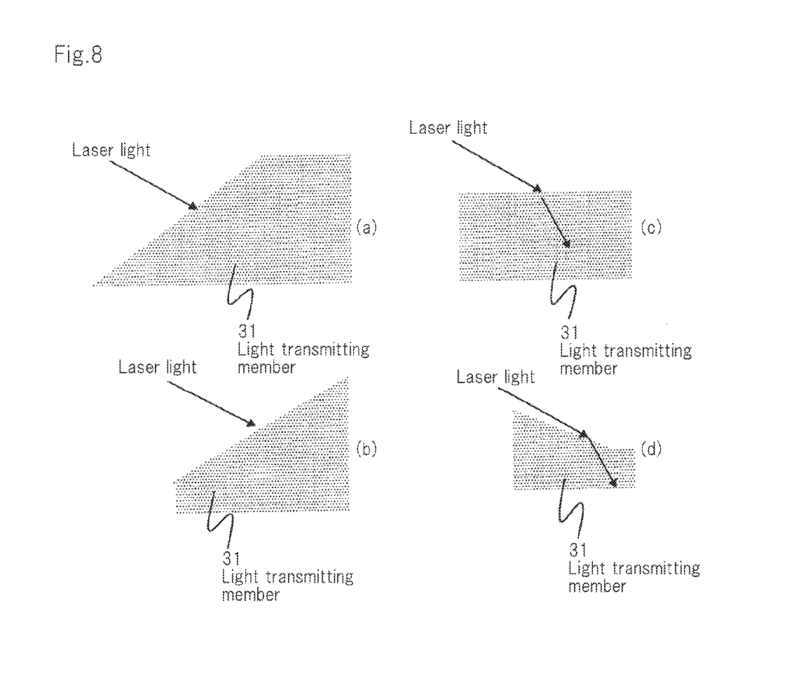

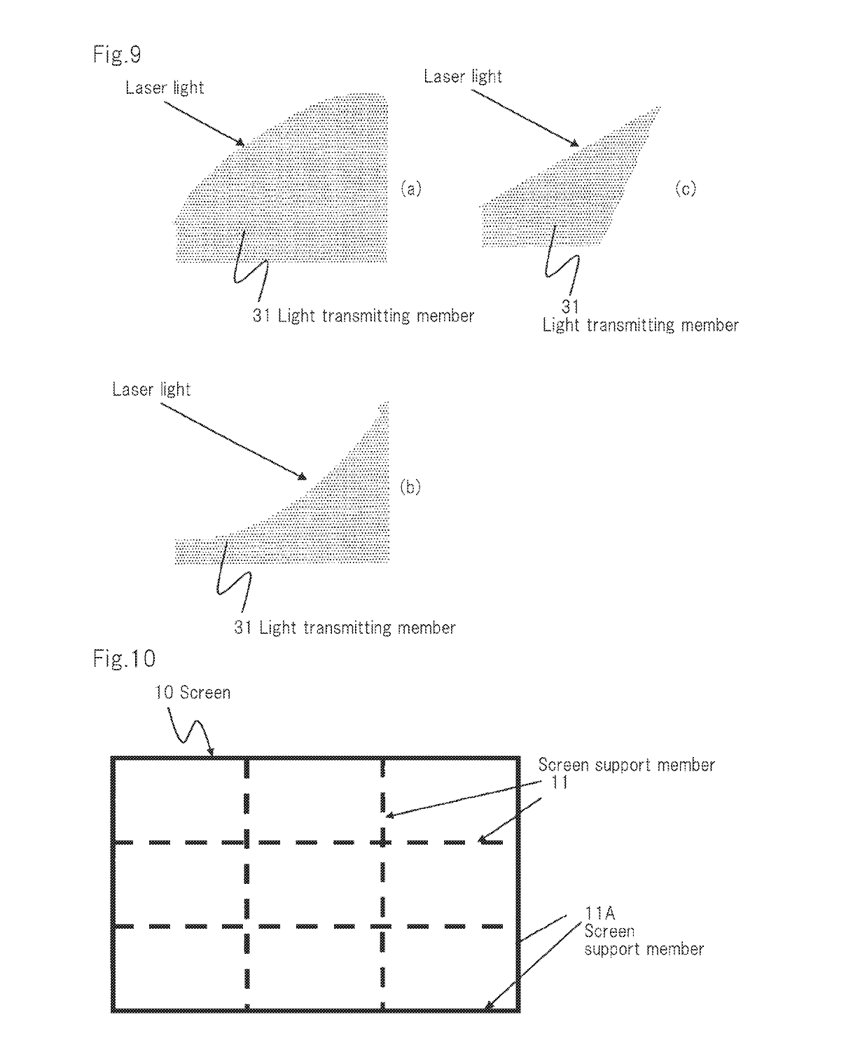

FIGS. 8 and 9 show other examples of the shape of light transmitting member 31.

Light transmitting member 31 may have a trapezoidal cross-sectional shape when cut in the direction perpendicular to the boundary line along which light transmitting member 31 is disposed by laser projection section 22 as shown in FIGS. 8(a) and 8(b) or may have a rectangular cross-sectional shape cut in the same manner as described above as shown in FIG. 8(c). Further, the orientation of the inclination may be reversed from that shown in FIG. 7 as shown in FIG. 8(d).

Further, light transmitting member 31 may have a curved incidence surface on which the laser light is incident as shown in FIGS. 9(a) and 9(b), or the surface through which the laser light is incident on low refractivity layer 33 may not be perpendicular to screen 10 as shown in FIG. 9(c).

Light transmitting members 31 shown in FIGS. 9(a) and 9(b) can deflect the diffused light from the adjacent unit toward optical sensor 23 in the unit itself by adjusting the curvature of the incident surface as appropriate. In this case, the sensitivity of optical sensor 23 can be improved.

Light transmitting member 31 shown in FIG. 9(c) allows the angle of incidence at which the laser light from the same unit is incident on low refractivity layer 33 to be reduced. In this case, it is more likely that the laser light is totally reflected.

As described above, the exemplary embodiment, which allows the diffused light produced by screen 10 to pass through low refractivity layer 33 while causing the laser light to be totally reflected off low refractivity layer 33, can prevent degradation in the quality of a displayed image while allowing detection of the light that an adjacent projector unit projects to form an image.

In the exemplary embodiment described above, the configuration shown in the drawings is presented by way of example, and the present invention is not limited to the configuration.

For example, a scanning-type projector that scans a screen with a light beam is used as each of projector units 1, but each of projector units 1 is not limited to a scanning-type projector and can be changed as appropriate.

Further, screen supports 11 may instead be disposed at at least a part of the boundary line and along the boundary line as long as optical sensor 23 in each of projector units 1 does not receive the laser light from an adjacent unit.

Further, screen supports 11A may further be provided along the edges of an image displayed by multiprojection system 100, as shown in FIG. 10. Each of screen supports 11A needs to include only one light transmitting member 31. In this case, no laser light produces diffused light in the exterior of multiprojection system 100 or light directly reflected off the screen does not leak out of multiprojection system 100, whereby safely can be improved.

The present application claims the priority based on Japanese Patent Application No. 2011-211283 filed on Sep. 27, 2011 and incorporates the entirety of the disclosure thereof.

### REFERENCE SIGNS LIST

1 Projector unit

10 Screen

11, 11A Screen support

21 Laser light source section

22 Optical sensor

23 Unit control section

31, 32 Light transmitting member

33 Low refractivity layer

34 Holding member

100 Multiprojection system

101 Overall controller

1. A multiprojection system comprising:
a plurality of projector units each projecting a formed image in such a way that the plurality of formed images are joined with each other to form a single displayed image;
a screen on which the plurality of formed images are projected;
a light transmitting, low refractivity area provided at at least a part of a boundary line between the formed images on the screen and along the boundary line; and
a pair of light transmitting members having a refractive index higher than the refractive index of the low refractivity area and provided so that the pair of light transmitting members sandwich the low refractivity area.

2. The multiprojection system according to claim 1,
wherein each of the projector units projects a light beam on a rear surface of the screen, and
the low refractivity area and the pair of light transmitting members are disposed on the rear surface of the screen.

3. The multiprojection system according to claim 1,
wherein a gap is provided as the low refractivity area between the pair of light transmitting members.

4. The multiprojection system according to claim 1,
wherein each of the light transmitting members is shaped to have an upward inclination with respect to a direction perpendicular to the boundary line on the screen.

5. The multiprojection system according to claim 4,
wherein each of the projector units outputs a light beam in such a way that the projector unit scans the screen with the light beam to project the formed image, and
an inclination angle α of the upward inclination is smaller than a scan angle θ in the scanning operation performed by the projector unit in a direction perpendicular to the boundary line and satisfies the following expression:
$$0 \leq α + {sin}^{- 1} ( \frac{{n}_{1}}{{n}_{2}} sin ( θ - α ) ) \leq {cos}^{- 1} ( \frac{{n}_{3}}{{n}_{2}} ) \qquad [ Formula 1 ]$$
where n1 represents the refractive index of each of the light transmitting members and n2 represents the refractive index of the low refractivity area.

6. The multiprojection system according to claim 1,
wherein each of the projector units includes a detector that detects light that an adjacent projector unit projects to form the formed image.

7. The multiprojection system according to claim 6,
wherein each of the projector units outputs a light beam on the screen to project the formed image, and
each of the detectors is disposed in an area except an area where the light beam outputted from the projector unit including the same detector passes through to the screen.

8. The multiprojection system according to claim 7,
wherein each of the detectors is disposed in an area through which light produced in a pixel located within a predetermined observation range in the formed image projected by a projector unit adjacent to the projector unit including the same detector passes.

9. The multiprojection system according to claim 1,
further comprising a holding member that holds the pair of light transmitting members.

10. The multiprojection system according to claim 9,
wherein the holding member blocks light.
